(19) United States
(12) Patent Application Publication
(10) Pub. No.: US 2009/0183944 A1
(43) Pub. Date: Jul. 23, 2009

(54) ACOUSTIC CORRECTION DEVICE

(76) Inventor: Francesco Pellisari, Rome (IT)

Correspondence Address: Steinfl & Bruno, 301 N Lake Ave Ste 810, Pasadena, CA, 91101, US

(21) Appl. No.: 12/300,934

(22) PCT Filed: May 17, 2006
(86) PCT No.: PCT/IT06/00369

§ 371 Date: Nov. 14, 2008

(51) Int. Cl. E04B 1/74; F21V 33/00

(52) U.S. Cl. 181/287; 362/145

(57) ABSTRACT

The present invention refers to a device for correcting the acoustic properties of an environment, comprising also acoustic emission means (4, 8, 8c, 8d, 8e, 8f, 8h, 8g), apt to be connected to a sound source to cover said environment; and means (3, 5, 7) for lighting said environment.

The present invention refers to a corrector, acoustic and light diffuser device, integrated in a single body, easily positionable, portable and with power supply and connections of simple use.

To date, in order to correct the acoustic qualities of an internal or external environment (resonance reduction and/or noise reduction) there are utilized sound-deadening bodies constituted by porous materials or by resonators; to improve performances, conical geometric shapes are utilized in order to break the wave and reduce the acoustic concentrations.

Said solutions are often unaesthetic and of difficult use in public environments, given the high fragility of the materials and the difficult cleaning thereof.

Object of the present invention is to make a device apt to solve the above-indicated problems, of easy positioning and portability, and concomitantly masking its presence with an aesthetically pleasing item, advantageously having a lighting and acoustic diffuser function.

These and other objects, that will be apparent to a person skilled in the art, are attained by a device in accordance with independent claim 1.

Secondary features of the present invention are defined in the corresponding dependent claims thereof.

In the device according to the invention, also the acoustic emission function is integrated to the acoustic correction and light source ones. This is advantageous in order to provide a single component concomitantly absolving the functions more required inside an environment.

The advantages, as well as the features and the operation modes of the present invention, will be made apparent in the following detailed description of preferred embodiments thereof, given by way of example and not for limitative purposes, making reference to the figures of the annexed drawings, wherein:

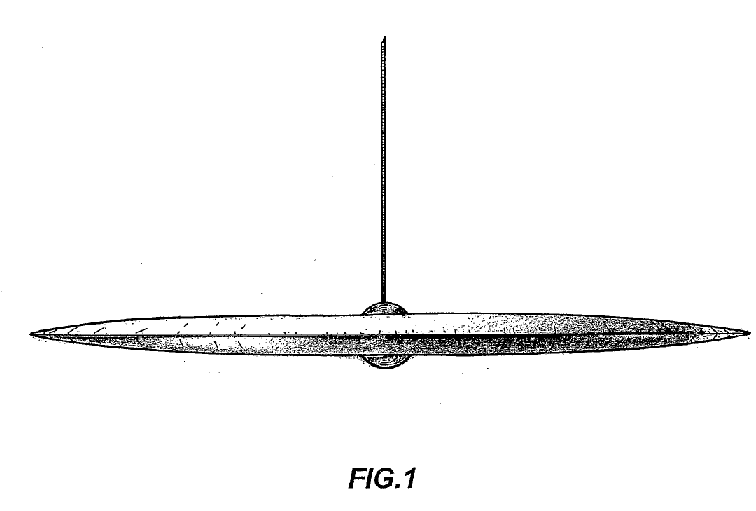

FIG. 1 is a 3D-view of a first embodiment of a device according to the present invention;

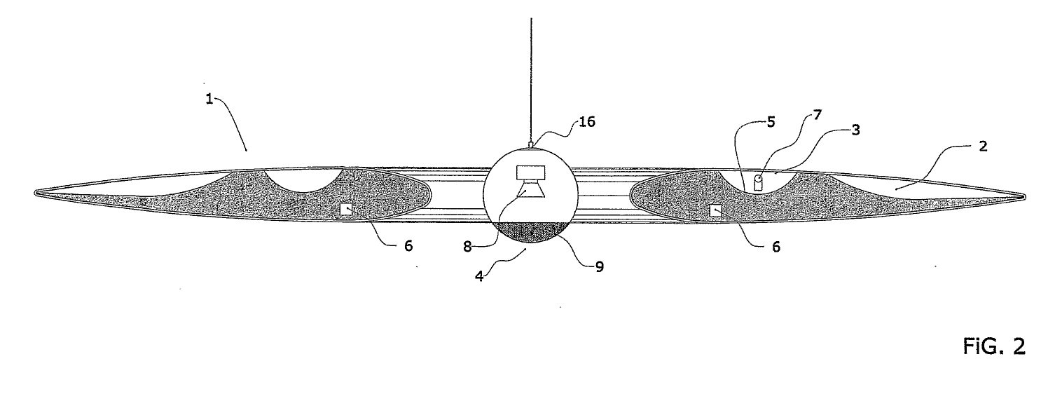

FIG. 2 is a partially sectional schematic view of the device of FIG. 1;

FIG. 3 is a schematic side view of a second embodiment of the device according to the present invention;

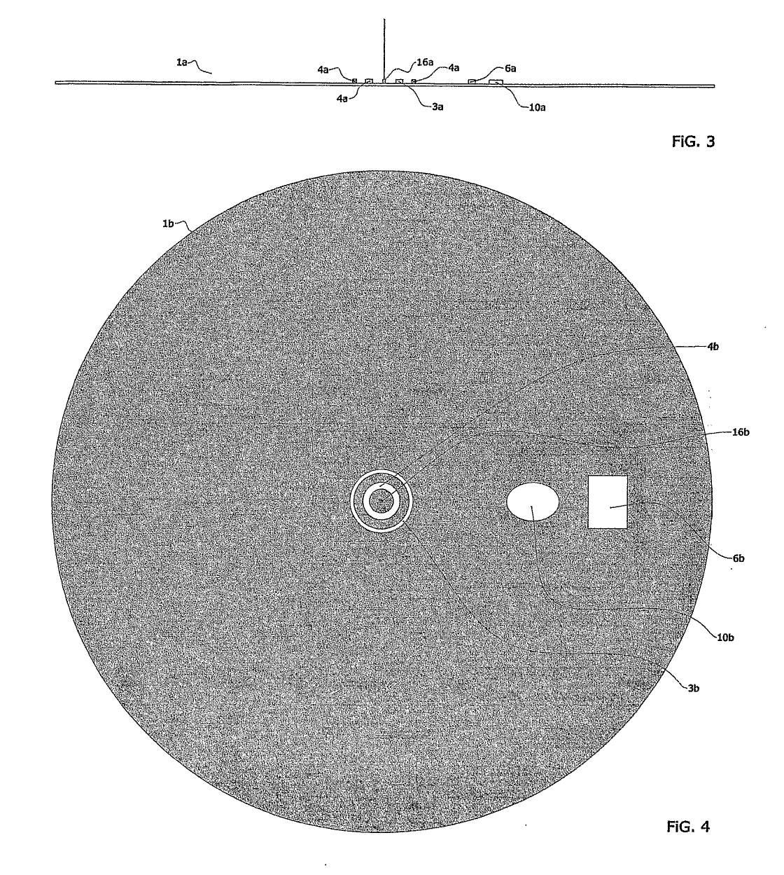

FIG. 4 is a schematic plan view of the device of FIG. 3;

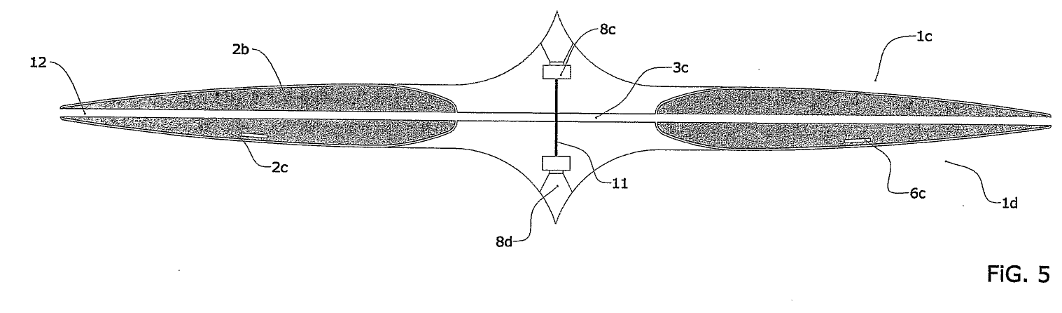

FIG. 5 is a partially sectional side view of a third embodiment of the device according to the present invention;

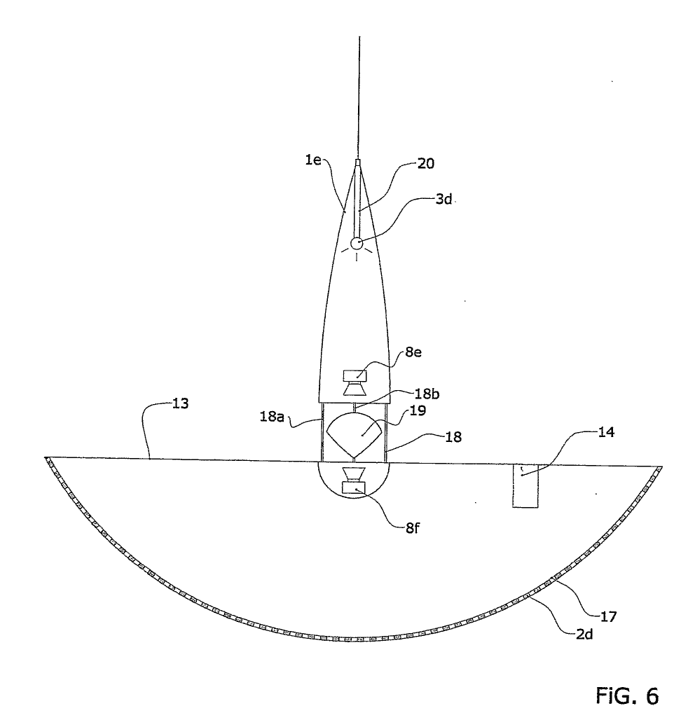

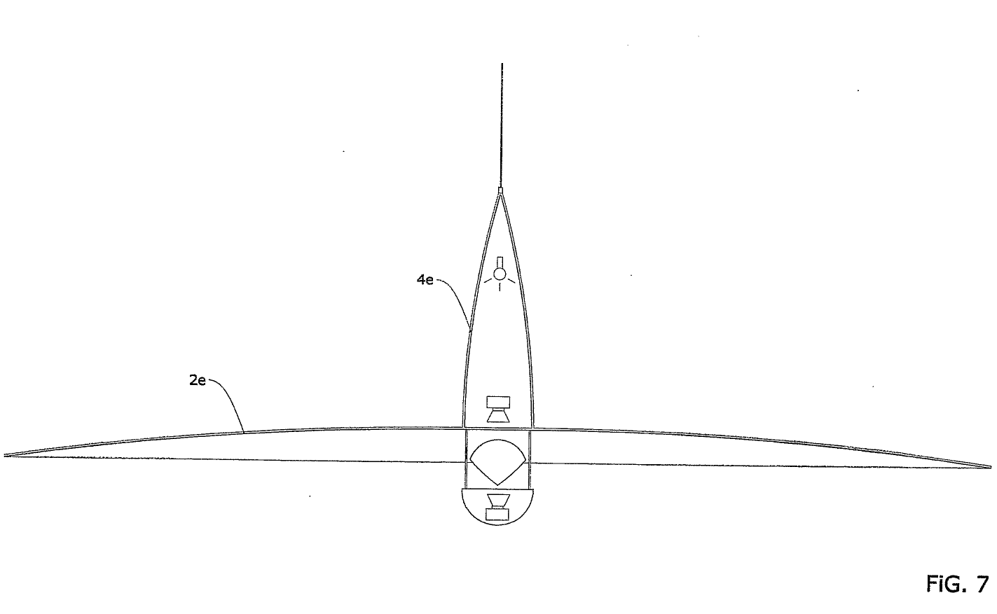

FIG. 6 is a partially sectional schematic view of a fourth embodiment of the device according to the present invention;

FIG. 7 is a partially sectional schematic view of a fifth embodiment of the device according to the present invention; and

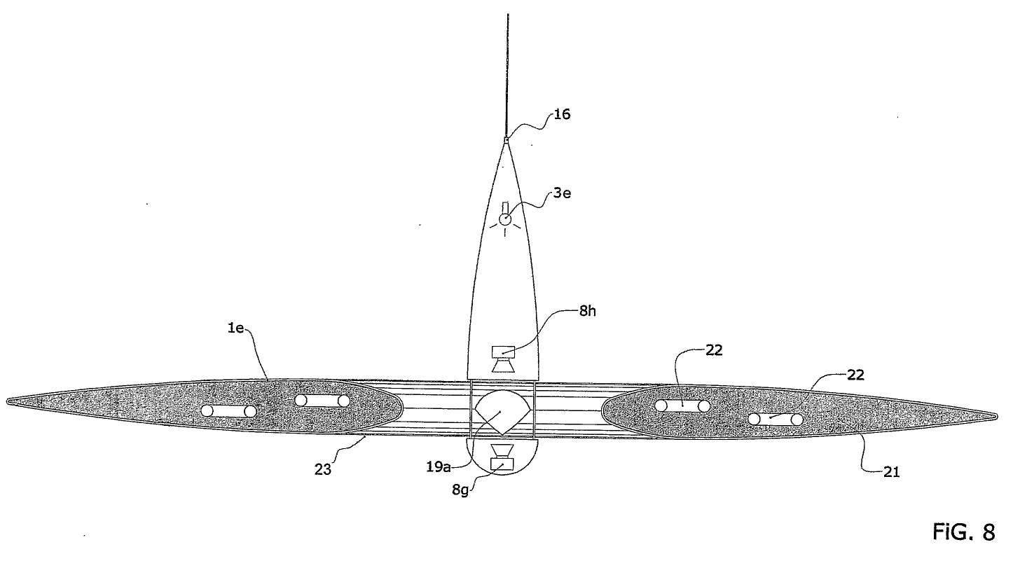

FIG. 8 is a partially sectional schematic view of a sixth embodiment of the device according to the present invention.

Hereinafter, the present invention will be described by way of example making reference to said figures.

According to a first embodiment of the invention, shown in FIGS. 1 and 2, a device according to the present invention comprises a main body 1 made, at least partially, of any one known material transparent to acoustic waves and concomitantly allowing, at least partially, the passage of light. The main body 1 is apt to house sound-deadening means 2, means 3 for emitting (diffusing) light and means 4, 8, for sound diffusion.

Said sound diffusion means comprises one or more conventional loudspeakers 8, preferably wide-band, with a frequency emission as wide as possible and sufficing to cover the space in which they are inserted.

Moreover, a protection grid 9 is provided, which in the specific instance is made by a portion of the body 1 modified at the part thereof in front of the loudspeaker 8.

The light-diffusing means 3 comprises one or more conventional-type lighting members 7, preferably fastened to a support 5 with the option of being removed in order to allow any replacement thereof.

Preferably, the lighting members 7 provide a light source sufficing to suitably light the space in which they are inserted and are positioned internally to the body 1.

Advantageously, inside the body 1 it is provided means 6 for receiving electric signals, comprising a receiver working with any one known technology (infrared, electromagnetic waves, conveyed waves, etc.). in the embodiment described, a Class 1 Bluetooth technology has been utilized, apt to receive the sound signal from a transmitter (not shown). Said received signal is then inputted to a power amplifier, apt to take the signal from the receiver and amplify it, in order to suitably drive the loudspeaker 8. The transmitter may be connected to any one audio source (not shown) such as a CD player, or a computer.

The power supply for the light diffusing 3 and receiving 6 means is provided by any one conventional technique. When the dimensions of the body 1 allow it, it is possible to adopt a power-supplying system with batteries in order to utilize the invention even on sites without power supply.

However, it is provided a support 16, through which it is possible to have a conventional electric connection and an easy positioning of the device onto the ceiling.

By hanging the body 1 inside an environment (having inserted therein a body with a very high absorption coefficient) the reverberation times are reduced, and, having inserted a diffusing surface, annoying sound concentrations are limited.

The option of directly connecting to a sound source eliminates the need of having a stereo system, it being possible to utilize a sound card or a CD, to date present on any computer.

Advantageously, the device according to the invention provides conventional means, manual as well as remote-controlled ones, for adjusting the intensity of sounds and light.

A second embodiment of the invention is shown in FIGS. 3 and 4. According to said embodiment, the main body integrates the three functions of acoustic, light and sound correction in a single body. In particular, the main body 1 is preferably made, at least partially, of a plate of a material apt to resonate at audible frequencies and, concomitantly, transparent to light.

The device further comprises means 10a, 10b sensitive to acoustic waves. Such means 10a, 10b, e.g. one or more microphones, connected to a processing system, e.g. a DSP, detect the resonances and/or noises present in the environment and calculate the frequency, the amplitude and the phase thereof. Then, the processing system produced a phase-shifted and amplified electric signal, apt to drive vibrating means 4a, 4b, rigidly fastened to the main body. The main body, by resonating in counterphase, attenuates the undesired frequencies present in the environment. It has to be considered that the same main body may suitably be designed in its dimensional proportions and in the rigidity of the material, in a manner such as to even passively attenuate resonances and the noises, by resonance of the panel itself.

To the main body, light is transmitted by any external source. In the exemplary case at issue, the main body is made with a conventional technical polymer apt to behave as optical fiber to which it is fastened conventional-type light-emitting means 3b, in the specific instance made by a crown of high-efficiency LEDs placed centrally to the main body.

Conveniently, the vibrating means 4a, 4b can, besides from carrying out the active acoustic correction function, concomitantly carry out the sound (acoustic) emission function, bringing into vibration the main body and therefore behaving as a planar loudspeaker, when driven through an external sound source.

Next, in FIG. 5 it is shown a third embodiment of a device according to the invention. Such a solution utilizes a pair of loudspeakers 8c and 8d, preferably with inverted taper, placed axially and with the diaphragms in opposition therebetween. Said system allows a stereophonic emission avoiding the need of having two devices in the same space.

In particular, according to said third embodiment, the main body of the device comprises two portions 1c, 1d made at least partially of a material transparent to audible frequencies and transparent to light.

The device comprises means sensitive to acoustic waves (not visible in the figure) which measure the resonances and/or noises in the environment, and, after suitable processing, produce an amplified electric signal, driving a means 11 for opening the bodies 1c and 1d, apt to mutually shift the bodies 1c and 1d, in a manner such as to mutually draw them apart or near. Said bodies 1c, 1d, by spacing apart therebetween, vary the absorbing surface 2b, 2c and the resonant volume 12, thereby best tuning onto the frequencies to be attenuated in the environment.

Inside the portions 1c and 1d it is placed conventional light-emitting means (not shown in figure). In the case at issue, such light-emitting means is placed centrally to the bodies 1c, 1d, having provided transparent diaphragms for the sound-emitting means 8d, 8c, in order to obtain a light effect coming from the center of the bodies and from the space 12 left open by the opening means 11.

Next, FIG. 6 refers to a fourth embodiment of a device according to the present invention.

In the embodiment of FIG. 6, the main body comprises acoustic correction means 2d made of a material transparent to sound, in the case at issue a drilled metal surface, with a sound-deadening fabric 17 inside applied thereto. The main body is closed with a drilled wall 13 in order to make, by cooperating with a duct 14, an acoustic resonator, whose resonance frequency is proportional to the air volume contained inside the body itself and by the duct 14. Conveniently, it is provided an active version, where the dimensions of the duct 14 are variable, e.g. by an DSP system, wherein one or more microphones detect the resonances and/or noises in the environment and, by suitable processing, produces (outputs) an electric signal apt to drive an actuator for varying the dimensions of the duct 14.

Concerning the acoustic and light emission, it has been envisaged the utilization of the omnidirectional technology described in Pat. Appl. No. 1M2000A000179 to the same inventor.

Said technology is briefly recalled for completeness' sake in the description.

According to this technology, there are provided two or more loudspeakers, axially placed with their opposed diaphragms 8e,8f suitably spaced by supports 18, 18a, 18b whose section does not influence the quality of the acoustic emission.

Centrally, it is inserted a wave guide 19 shaped in order to convey the acoustic waves of the two acoustic generators 83, 8f and substantially emit an omnidirectional acoustic emission.

Conveniently, the body 1e is made of any known transparent material in order to be lighted with a conventional light source 3d. In the case at issue, there has also been utilized a particular contrivance, in which the acoustic duct 20 is made by a cylinder of suitable diameter and length in order to resonate at a specific frequency apt to increase the effectiveness of the system at low frequencies (reflex duct) and dissipate the thermal energy produced internally.

Next, FIG. 7 refers to a fifth embodiment of a device according to the present invention. In the embodiment of FIG. 7, the acoustic correction means 2e is made by a disc-shaped body, directing the sound emitted by the means 4e only along a desired direction, e.g. bottomwise. Thus, the acoustic behavior of the environment is only marginally affected, yet the directional property of the acoustic source to attain the desired acoustic quality and prevent the onset of annoying resonances.

Next, FIG. 8 refers to a sixth embodiment of a device according to the present invention. In the embodiment of FIG. 8 the device comprises a body 1e made, at least partially, of any one known material apt to absorb and/or reflect acoustic waves, apt to contain, at least partially, sound-deadening means 2f, in the case at issue made of porous materials 21 and/or resonant volumes 22 and/or resonant plates 23. An acoustic system thus composed may be activated over a very precise frequency band, by utilizing, e.g., the resonant volumes for the low range, the resonant plates for the medium-high range and the porous material as median absorbing element for the entire audio range.

Conveniently, in this case as well it is provided an active adjustment system, apt to dynamically vary the diameter of the ducts of the resonant volumes and the voltage of the resonant plates.

The two acoustic generators 8g e 8h, are placed coaxially therebetween and frontally coupled, with the diaphragms arranged the ones in front of the others, and emit separately two acoustic waves. By the wave guides 19a, the diaphragms irradiate an omnidirectional acoustic wave onto the plane perpendicular to the axis of the loudspeakers themselves.

Thanks to the omnidirectional emission, it is possible to freely listen it from any one location. The frustoconical main body 1e itself behaves as ventilation duct for the means 3d, with the twin function of transmission line for the loudspeaker 8h and partial container for the entire system.

The present invention has hereto been described according to preferred embodiments thereof, given by way of example and not for limitative purposes. It is understood that other embodiments might be envisaged, all to be construed as falling within the protective scope thereof, as defined by the annexed claims.

1.-22. (canceled)

23. An environmental acoustic correction device, comprising
means for lighting an environment, and
a main body including means for correcting acoustic properties of said environment, apt to reduce resonances of said environment and/or to correct a frequency response of said environment.

24. The device according to claim 23, wherein said main body has dimensions apt to perceptibly reduce in a passive way the resonance frequencies of said environment.

25. The device according to claim 23, wherein said main body is apt to house said lighting means.

26. The device according to claim 23, wherein said main body is made, at least partially, of a plate apt to resonate at predetermined resonance frequencies of said environment, to obtain a perceptible reduction of the resonances of said environment.

27. The device according to claim 23, wherein said main body is further apt to house sound-deadening means for resonance frequencies of said environment, to obtain a perceptible reduction of the resonances of said environment.

28. The device according to claim 23, wherein said main body is made, at least partially, of material substantially transparent to acoustic waves.

29. The device according to claim 23, wherein said main body is made, at least partially, of material apt to absorb and/or reflect acoustic waves at the resonance frequencies of said environment, to obtain a perceptible reduction of the resonances of said environment.

30. The device according to claim 29, wherein said material apt to absorb and/or reflect acoustic waves, is shaped, at least partially, as resonant volumes and/or resonant plates, resonating at the resonance frequencies of said environment, in order to introduce a tuned absorption inside the environment.

31. The device according to claim 23, wherein said main body comprises two portions, interconnected therebetween at a distance which is function of the resonance frequencies of said environment.

32. The device according to claim 31, further comprising means sensitive to acoustic waves, apt to meter the resonances in the environment, generating a corresponding control signal.

33. The device according to claim 32, further comprising opening means, driven by said control signal, and apt to modify the mutual distance of said portions of main body.

34. The device according to claim 23, comprising at least one resonant duct, resonating at the resonance frequencies of said environment, to obtain a perceptible reduction of the resonances of said environment.

35. The device according to claim 34, wherein said at least one resonant duct is of variable dimensions.

36. The device according to claim 35, further comprising a processing system apt to drive one or more actuators for varying the dimensions of the duct.

37. The device according to claim 23, further comprising acoustic emission means, apt to be connected to a sound source to cover said environment.

38. The device according to claim 37, further comprising an acoustic and/or light omnidirectional emission system.

39. The device according to claim 38, wherein said omnidirectional emission system comprises one or more wave guides.

40. The device according to claim 39, wherein said omnidirectional emission system comprises two coaxial and opposing loudspeakers and a wave guide centrally placed between them.

41. The device according to claim 37, further comprising means for receiving electric signals from said sound source by wireless technologies.

42. The device according to claim 37, further comprising means for amplifying the electric signals received from said sound source.

43. The device according to claim 37, further comprising an ancillary power-supplying device.

44. The device according to claim 37, further comprising means for remote-controlling one or more of the functions thereof.

45. The device according to claim 37, wherein said acoustic emission means is preset for a stereophonic emission.

46. The device according to claim 37, wherein said acoustic emission means comprises at least two loudspeakers, coupled in a manner such as to have respective inverted tapers.

47. The device according to claim 23, further comprising fastening elements apt to stably connect the device itself to a wall, floor or ceiling.

48. An environmental acoustic correction device, comprising
acoustic emission means, apt to be connected to a sound source to cover an environment;
means for lighting said environment; and
a main body including means for correcting acoustic properties of said environment, apt to reduce resonances of said environment and/or to correct a frequency response of said environment.

49. The device according to claim 48, wherein said main body has dimensions apt to perceptibly reduce in a passive way the resonance frequencies of said environment.

50. The device according to claim 48, wherein said main body is apt to house said acoustic emission means and said lighting means.

51. The device according to claim 48, wherein said main body is made, at least partially, of a plate apt to resonate at predetermined resonance frequencies of said environment, to obtain a perceptible reduction of the resonances of said environment.

52. The device according to claim 48, wherein said main body is further apt to house sound-deadening means for resonance frequencies of said environment, to obtain a perceptible reduction of the resonances of said environment.

53. The device according to claim 48, wherein said main body is made, at least partially, of material substantially transparent to acoustic waves.

54. The device according to claim 48, wherein said main body is made, at least partially, of material apt to absorb and/or reflect acoustic waves at the resonance frequencies of said environment, to obtain a perceptible reduction of the resonances of said environment.

55. The device according to claim 54, wherein said material apt to absorb and/or reflect acoustic waves, is shaped, at least partially, as resonant volumes and/or resonant plates, resonating at the resonance frequencies of said environment, in order to introduce a tuned absorption inside the environment.

56. The device according to claim 48, wherein said main body comprises two portions, interconnected therebetween at a distance which is function of the resonance frequencies of said environment.

57. The device according to claim 56, further comprising means sensitive to acoustic waves, apt to meter the resonances in the environment, generating a corresponding control signal.

58. The device according to claim 57, further comprising opening means, driven by said control signal, and apt to modify the mutual distance of said portions of main body.

59. The device according to claim 48, further comprising an acoustic and/or light omnidirectional emission system.

60. The device according to claim 59, wherein said omnidirectional emission system comprises one or more wave guides.

61. The device according to claim 60, wherein said omnidirectional emission system comprises two coaxial and opposing loudspeakers and a wave guide centrally placed between them.

62. The device according to claim 48, comprising at least one resonant duct, resonating at the resonance frequencies of said environment.

63. The device according to claim 62, wherein said at least one resonant duct is of variable dimensions.

64. The device according to claim 63, further comprising a processing system apt to drive one or more actuators for varying the dimensions of the duct.

65. The device according to claim 48, further comprising means for receiving electric signals from said sound source by wireless technologies.

66. The device according to claim 48, further comprising means for amplifying the electric signals received from said sound source.

67. The device according to claim 48, further comprising an ancillary power-supplying device.

68. The device according to claim 48, further comprising means for remote-controlling one or more of the functions thereof.

69. The device according to claim 48, wherein said acoustic emission means is preset for a stereophonic emission.

70. The device according to claim 48, wherein said acoustic emission means comprises at least two loudspeakers, coupled in a manner such as to have respective inverted tapers.

71. The device according to claim 48, further comprising fastening elements apt to stably connect the device itself to a wall, floor or ceiling.
